(19) United States
(12) Patent Application Publication
(10) Pub. No.: US 2013/0012393 A1
(43) Pub. Date: Jan. 10, 2013

(54) APPARATUS TO CONFINE A PLURALITY OF CHARGED PARTICLES

(76) Inventors: Daniel Bateman, San Francisco, CA (US); Shahin Pourrahimi, Brookline, MA (US)

(21) Appl. No.: 13/544,906

(22) Filed: Jul. 9, 2012

Related U.S. Application Data
(60) Provisional application No. 61/505,330, filed on Jul. 7, 2011.

(51) Int. Cl. H01F 6/06; H01F 6/04; F25B 9/00; H01F 6/00

(52) U.S. Cl. 505/163; 62/6; 335/216

(57) ABSTRACT

The present invention is an apparatus to confine a plurality of charged particles that include a plurality of coil heads that includes a plurality of superconducting coils, a bobbin and a plurality of insulation material and a plurality of support legs that include 2 support legs that are in conductive contact with each coil head and 2 support legs that are in physical contact with each coil head. The apparatus includes a base with a cryocooler inlet and a vacuum flange and a conductive cold element that is in the interior of the base, the conductive cold element is attached to the conductive rods of the 2 support legs that are in conductive contact with each coil head and the superconducting coils.

This application claims priority to U.S. Provisional Application 61/505,330 filed on Jul. 7, 2011, the entire disclosure of which is incorporated by reference.

### TECHNICAL FIELD & BACKGROUND

The present invention is in the field of an apparatus to confine a plurality of charged particles with a plurality of superconductive coils, the outermost container of such coils held at high voltage relative to ground.

### SUMMARY OF THE INVENTION

When superconductive coils are charged, they exert force on each other as a result of the Lorentz effect. In one embodiment, when six coils are perfectly arranged, each coil on one of the six surfaces of a general cube orientation, each coil experiences a net force in a direction that is normal to the cubic surface on which it resides. The force on a coil from the coil that is on its opposite side is entirely normal to the cubic surface on which it resides. Non-normal forces that are due to other coils cancel each other out due to symmetry. Depending on the design and operating parameters, the net normal force on each coil are in the range of approximately 10,000 N to 1,000,000 N or more. In practical applications the coils may not reside in their ideal locations, may not be charged to exactly the same magnetic field, or due to transient conditions, one or more coils may be discharged or discharging. When one or more of these conditions are present, each of the six coils will experience imbalanced forces that could lead to relatively larger normal forces as well as forces in other directions and torque. Among the main challenges of design of superconducting coils for an apparatus are the accommodations of a plurality of forces and torques that can be expected to arise during the full range of operational conditions of the apparatus.

In another embodiment, four coils are perfectly arranged, each coil on one of the four surfaces of a general tetrahedral orientation. In another embodiment, twelve coils are perfectly arranged, each coil on one of the twelve surfaces of a general dodecahedral orientation.

Superconducting coils need to operate at temperatures below the critical temperature of the superconducting wire that is used to make the superconducting coil. Critical temperatures of typical superconductors are approximately below 80 K. Critical temperatures of superconducting wires used in many commercial superconducting magnet applications like an MRI and an NMR are in the range of approximately 4 K to 15 K. These types of wires are referred as low temperatures superconductor or (LTS) wires. An apparatus application may use LTS wires and coils, or wires and coils that operate at higher temperatures. It is advantageous to transmit the forces and torques that act on the superconducting coils to structural members that connect the coils to other structural members that are approximately at room temperature. In such a case, the structural members that transmit forces and torques or support legs conduct heat from the room temperature structural members to the superconducting coils. Clearly, it is advantageous to keep the heat conduction or heat leak through the support legs to a minimum. So a challenge in designing an efficient apparatus that uses superconducting coils is to optimize the design of the support structure for adequate mechanical performance with minimized heat leak.

In one embodiment of the present invention, an apparatus to confine a plurality of charged particles is provided with a support structure for adequate mechanical performance with minimized heat leak that is absent from a traditional apparatus to confine a plurality of charged particles.

In one embodiment of the present invention, an apparatus to confine a plurality of charged particles is provided with a plurality of accommodations of a plurality of forces and torques that can be expected to arise during the full range of operational conditions of the apparatus.

In one embodiment of the present invention, an apparatus to confine a plurality of charged particles is provided with a plurality of reinforced superconducting coils in contrast to traditional superconducting coils.

In one embodiment of the present invention, an apparatus to confine a plurality of charged particles is isolated for well suited performance.

In one embodiment of the present invention, the outermost container of each superconductive coil is held at high voltage (1,000 Volts to 500,000 Volts or more) relative to ground, to attract charged particles radially inward toward the central point of the apparatus.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a front perspective view of a configuration of an apparatus to confine a plurality of charged particles, in accordance with one embodiment of the present invention.

FIG. 2A illustrates a front perspective view of an apparatus to confine a plurality of charged particles, in accordance with one embodiment of the present invention.

FIG. 2B illustrates a front cross-sectional perspective view along line 2A-2A of FIG. 2A of an apparatus to confine a plurality of charged particles, in accordance with one embodiment of the present invention.

FIG. 2C illustrates a back cross-sectional perspective view along line 2A′-2A′ of FIG. 2A of an apparatus to confine a plurality of charged particles, in accordance with one embodiment of the present invention.

FIG. 3 illustrates a cross-sectional view along line 2C-2C of FIG. 2C of a coil head of an apparatus to confine a plurality of charged particles, in accordance with one embodiment of the present invention.

FIG. 4 illustrates a cross-sectional view along line 2C-2C of FIG. 2C of a coil head of an apparatus to confine a plurality of charged particles, in accordance with one embodiment of the present invention.

FIG. 5 illustrates a cross-sectional view along line 2C-2C of FIG. 2C of a coil head of an apparatus to confine a plurality of charged particles, in accordance with one embodiment of the present invention.

### DETAILED DESCRIPTION OF ILLUSTRATIVE EMBODIMENTS

Various aspects of the illustrative embodiments will be described utilizing terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

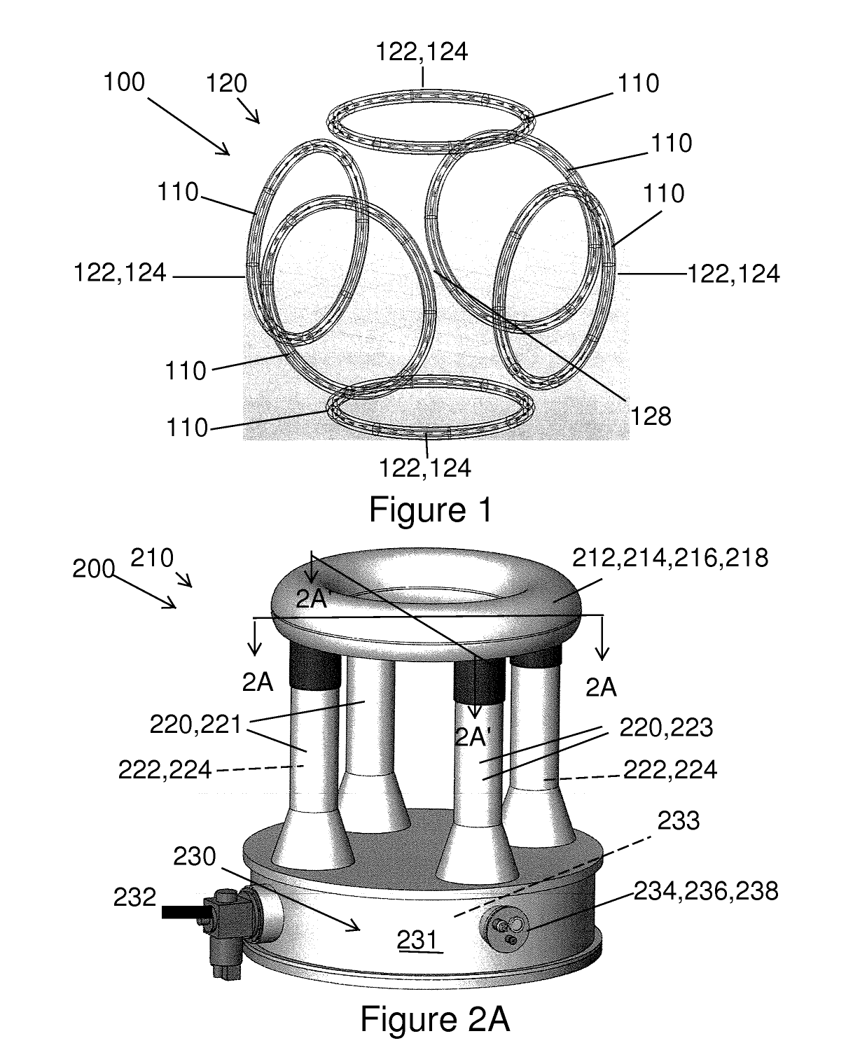

FIG. 1 illustrates a front perspective view of a configuration of an apparatus to confine a plurality of charged particles 100, in accordance with one embodiment of the present invention.

The apparatus to confine a plurality of charged particles 100 includes one or more superconducting coils 110. FIG. 1 illustrates 6 superconducting coils 110 however any suitable number of super conducting coils such as 2, 3, 4, 5, 7, 8 or 10 superconducting coils can be utilized. The 6 superconducting coils 110 are arranged such that each superconducting coil 110 is placed on one of six square surfaces 122 of a cube orientation 120, with an axial center 112 of each superconducting coil 110 being coincident with a center 124 of each of the square surfaces 122 of the cube orientation 120. The superconducting coils 110 are charged so a magnetic field (not shown) from each of the superconducting coils 110 points towards a center 128 of the cube orientation 120.

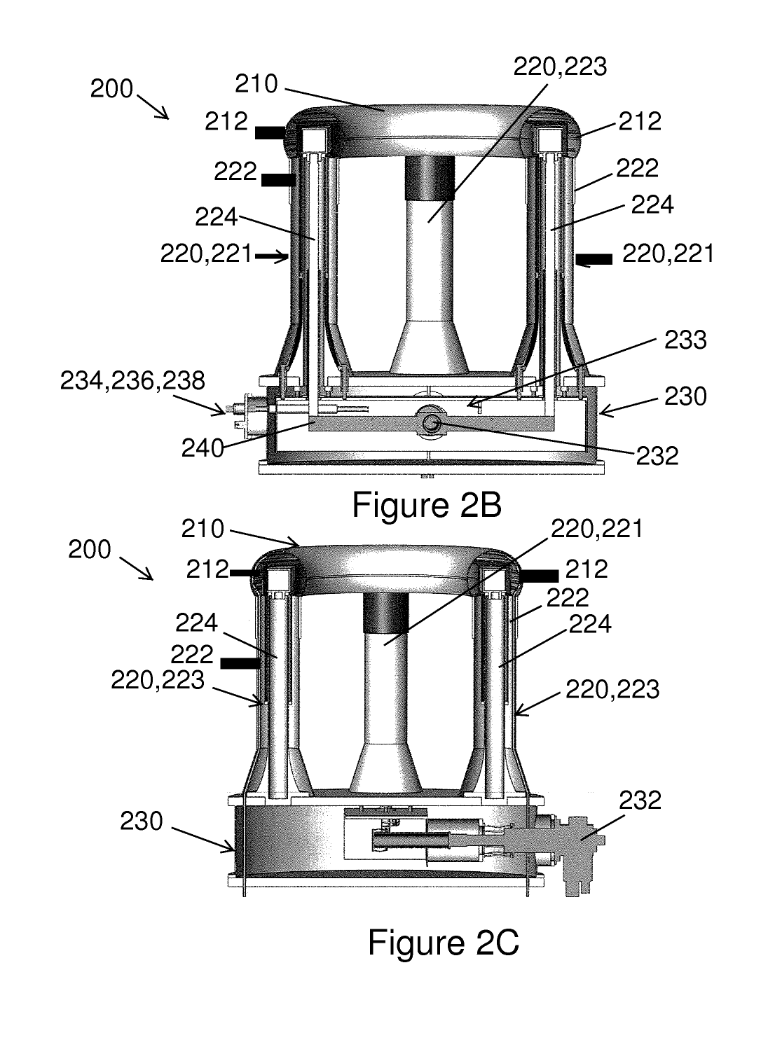

FIG. 2A illustrates a front perspective view of an apparatus to confine a plurality of charged particles 200, in accordance with one embodiment of the present invention. The apparatus to confine a plurality of charged particles 200 illustrated in FIG. 2A is similar to the apparatus to confine a plurality of charged particles 100 illustrated in FIG. 1.

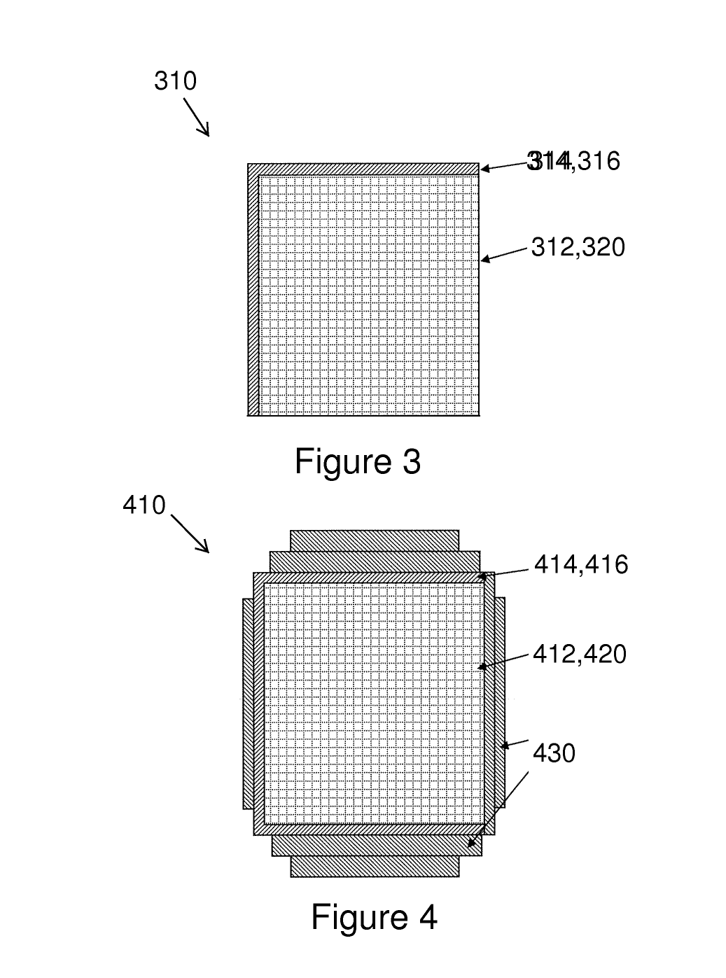

The apparatus to confine a plurality of charged particles 200 includes a plurality of coil heads 210 that can be any suitable number of coil heads. FIG. 2A illustrates a coil head 210 that includes a plurality of support legs 220 and a base 230. The coil head 210 houses one or more superconducting coils 212, a bobbin 214, a structural support 216 and a plurality of insulation material 218. Additional details regarding the superconducting coils 212, the bobbin 214, the structural support 216 and the insulation material 218 are provided in FIGS. 3, 4 and 5. FIG. 2A illustrates 4 support legs 220, although any suitable number of support legs such as 3, 5, 6, 7, 8 or more support legs can be provided. The 4 support legs 220 include 2 support legs 221 that are in conductive contact with the coil head 210 and 2 support legs 223 that are simply in physical contact with the coil head 210. The 2 support legs 221 that are in conductive contact with the coil head 210 and superconducting coils 212 that house a plurality of insulation material 222 and a conductive rod 224. The base 230 includes an exterior 231 and an interior 233 with a cryocooler inlet 232 disposed on the exterior 231 of the base 230 and a vacuum flange 234 disposed on the exterior 231 of the base 230. The cryocooler inlet 232 receives a cryocooler device (not shown) that provides cooling to the apparatus to confine a plurality of charged particles 200. The vacuum flange 234 is at least one port needed to utilize electrical instrumentation and current leads. The vacuum flange 234 is used to transition one or more instrumentation wires like one or more leads 236 to one or more temperature sensors 238 and current leads 236 to the superconducting coils 212 from ambient condition to inside the apparatus to confine a plurality of charged particles 200.

FIG. 2B illustrates a front cross-sectional perspective view along line 2A-2A of FIG. 2A of an apparatus to confine a plurality of charged particles 200, in accordance with one embodiment of the present invention. The apparatus to confine a plurality of charged particles 200 illustrated in FIG. 2B is similar to the apparatus to confine a plurality of charged particles 200, the coil head 210, the plurality of support legs 220 and the base 230 as illustrated in FIG. 2A.

The apparatus to confine a plurality of charged particles 200 additionally includes a conductive cold element 240. The conductive cold element 240 is in the interior 233 of the base 230 and is attached to the conductive rods 224 of the 2 support legs 221 that are in conductive contact with the coil head 210 and the superconducting coils 212. The conductive cold element 240 is also in communication with the cryocooler inlet 232 to receive the cryocooler device (not shown) that provides cooling to the apparatus to confine a plurality of charged particles 200. The conductive cold element 240 and the conductive rods 224 are made of copper however the conductive cold element 240 and the conductive rods 224 can be made of any suitable conductive material.

FIG. 2C illustrates a back cross-sectional perspective view along line 2A′-2A′ of FIG. 2A of an apparatus to confine a plurality of charged particles 200, in accordance with one embodiment of the present invention. The apparatus to confine a plurality of charged particles 200 illustrated in FIG. 2C is similar to the apparatus to confine a plurality of charged particles 200, the coil head 210, the plurality of support legs 220 and the base 230 as illustrated in FIG. 2B.

FIG. 2C includes 2 support legs 223 that are simply in physical contact with the coil head 210. The 2 support legs 223 that are simply in physical contact with the coil head 210 are not provided with the conductive rods 224 and are not attached to the conductive cold element 240. The 2 support legs 223 does include insulation material 222 that is similar to the insulation material 222 provided in the 2 support legs 221 that are in conductive contact with the coil head 210.

FIG. 3 illustrates a cross-sectional view along line 2C-2C of FIG. 2C of a coil head 310 of an apparatus to confine a plurality of charged particles, in accordance with one embodiment of the present invention.

The coil head 310 houses a plurality of superconducting coils 312, a bobbin 314, and a plurality of insulation material 316 illustrated in FIG. 3 that is similar to the coil head 210 that houses the plurality of superconducting coils 212, the bobbin 214 and the plurality of insulation material 216 that is illustrated in FIG. 2A.

The superconducting coils 312 form a winding pack 320 that are secured by the bobbin 314. The bobbin 314 facilitates the superconducting coils 312 to achieve relatively higher performance that the superconducting coils 312 need to produce relatively higher magnetic fields and therefore will experience relatively larger forces and torques.

FIG. 4 illustrates a cross-sectional view along line 2C-2C of FIG. 2C of a coil head 410 of an apparatus to confine a plurality of charged particles, in accordance with one embodiment of the present invention. The coil head 410 of an apparatus to confine a plurality of charged particles 400 illustrated in FIG. 4 has a similar plurality of superconducting coils 412, bobbin 414, insulation material 416 and winding pack 420 illustrated in FIG. 3.

The coil head 410 of an apparatus to confine a plurality of charged particles 400 additionally includes one or more structural supports 430. The one or more structural supports 430 are provided adjacent to the bobbin 414 and the winding pack 420 from the superconducting coils 412. The one or more structural supports 430 are provided around the winding pack 420 due to the increase in relatively higher magnetic fields from the winding pack 420 and therefore will experience relatively larger forces and torques.

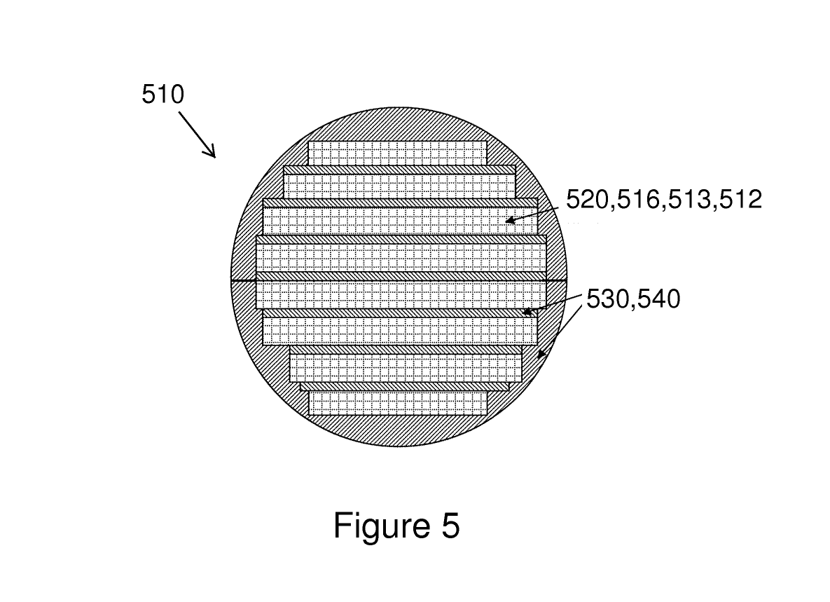

FIG. 5 illustrates a cross-sectional view along line 2C-2C of FIG. 2C of a coil head 510 of an apparatus to confine a plurality of charged particles, in accordance with one embodiment of the present invention. The coil head 510 of an apparatus to confine a plurality of charged particles 500 illustrated in FIG. 5 has similar superconducting coils 512, insulation material 516 and winding pack 520 illustrated in FIG. 4.

The head 510 of an apparatus to confine a plurality of charged particles 500 additionally includes a plurality of solid strips 530 of relatively high strength material within the winding pack 520 and the structural support 540. The relatively high strength material can be stainless steel, nickel alloy or other super alloys or other suitable material. The superconducting coils 512 are also reinforced superconducting coils 513 which are better-suited than traditional superconducting coils 512 and provide relatively higher magnetic fields from the winding pack 520 and therefore will experience relatively larger forces and torques.

In the apparatus to confine a plurality of charged particles, six individual superconducting coils are arranged such that each superconducting coil is placed on one of six surfaces of an imaginary cube, with the axial center of the coils being coincident with the center of the squares on the faces of the cube. All six coils are charged so that the magnetic field of each coil points towards the center of the cube. The combined magnetic field of the six coils can provide magnetic confinement to the charged particles in the space between the six coils.

In using LTS superconducting coils, it is advantageous to cool the magnet by a cryogen-free approach, where one or more coils are kept cool by connecting them to one or more cryocoolers. Typical cryocoolers that are used in cryogen-free LTS superconducting magnets are two-stage devices, where the first stage can expel heat in the approximate range of 5 to 50 W in the approximate range of 40 to 70 K, and the second stage expels heat in the approximate range of 0.5 to 10 W in the range of approximately 4 to 12 K. Often the cryostat of a cryogen-free superconducting magnet includes a radiation shield that isolates the superconducting coil from thermal radiation heat of the cryostat surface. The radiation shield intercepts the thermal radiation heat and conducts the heat to the first stage of the cryocooler. Typically, there is a blanket of multi-layer superinsulation over the radiation shield. Typically a radiation shield is maintained in the range of approximately 40K to 70K. Therefore, the LTS superconducting coil, which needs to remain at a temperature in the range of approximately 4K to 12K, is exposed to radiation from a surrounding surface that is in the approximate range of 40K to 70K instead of at approximately 300K. The use of the radiation shield reduces the heat input to the superconducting coil in the approximate range of one to two orders of magnitude. A few layers of superinsulation may be applied over the coil and other parts of the apparatus that need to remain in the range of 4K to 12K to further reduce the radiation heat leak from the radiation shield. In the apparatus design the superconducting coil is supported by four legs. However, depending on the specific apparatus size and application, the number of legs may be in the approximate range of 2 to 6 or more. A coil supported by a discrete number of legs that is subjected to a substantial normally distributed load will undergo deflections and mechanical strain that could damage, or negatively affect, the superconducting coil. The need for reducing heat leak combined by support legs that will be subject to collision by charged particles, leads to the need to reduce the number of support legs. Reducing the number of support legs leads to longer spans between support legs and, therefore, potential for larger deflection and strain experienced by the coil mounted on the legs. A challenge in designing an apparatus that uses superconducting coils is to ensure that the strain that the coils experience are kept below allowable values for the specific superconducting wires used in the coils. The superconducting coils are windings of a plurality of superconducting wires, or cables of wires, that are held together by a bonding material such as epoxy. Therefore, mechanical properties of the coils are derived from properties of superconducting wires and the bonding material that holds the coils together.

Often, superconducting coils are wound on a bobbin, which remains as an integral part of the coil and can contribute to the mechanical integrity of the coil. Also the outermost surface of the container or cryostat of the superconducting magnet assembly may be exposed to energetic charged particles. If the outermost surface of the container is electrically conductive, an electric field may be applied such that the surface is held at relatively high voltage. Charged particles attracted to the surface will be shielded from striking the surface by the magnetic field, provided that the magnetic field lines are parallel throughout the surface. In this manner, a higher magnetic field will allow a higher voltage to be held on the surface before arcing occurs in the surrounding environment. Therefore, in a given apparatus application, it is desirable to maximize the magnetic field at the outermost surface of the individual superconducting magnets. The descriptions make the following points about apparatuses that use superconducting coils:

1) Coils will be subject to large Lorentz forces.

2) Coils will have a discrete number of support legs.

3) Coils will experience mechanical strain.

4) Strain that Superconducting coils experience need to remain below certain allowable values.

5) Apparatuses benefit from having high magnetic fields at the surface of their magnet cryostats.

A wire wound on a bobbin may be considered a conventional coil. To achieve relatively higher performance the coil needs to produce relatively higher magnetic fields and therefore will experience relatively larger forces and torques, and therefore the coil would need to have more structural support. A conventional approach to add more structure would be to add extra structure around the winding pack. The apparatus teaches a method to provide mechanical support to individual superconducting coils that reduce strain as well as help increase the magnetic field at the surface of individual cryostats. The method involves one or more of the following steps:

a) Adding solid strips of high strength material to within the winding pack.

b) Shaping the coil according to the limitation posed by the cryostat.

c) Using reinforced superconductor wires.

Advantages of the mechanically supported supercoil include:

1) Superconducting wire-turns within the winding pack, that are prone to damage by excessive strain, are supported closer to the where the wire-turns are.

2) The circular cross-section allows for use of a larger area within a given cryostat that has a circular cross section.

3) The wire-turns are spread such that they are closer to the cryostat surface.

The advantages lead to a stronger coil that can produce a relative higher magnetic field within a comparable apparatus space, and even higher relative magnetic field at the surface of the cryostat.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. An apparatus to confine a plurality of charged particles, comprising:
a plurality of coil heads, each said coil head includes one or more superconducting coils, a bobbin and a plurality of insulation material;
a plurality of support legs that include 2 support legs that are in conductive contact with said each coil head and 2 support legs that are in physical contact with said each coil head;
a base that includes an exterior and an interior, said base has a cryocooler inlet disposed on said exterior of said base and a vacuum flange disposed on said exterior of said base; and
a conductive cold element that is in said interior of said base, said conductive cold element is attached to said conductive rods of said 2 support legs that are in conductive contact with said each coil head and said superconducting coils, said conductive cold element is in communication with said cryocooler inlet to receive a cryocooler device that provides cooling to said apparatus to confine a plurality of charged particles.

2. The apparatus according to claim 1, wherein said superconducting coils form a winding pack that is secured by said bobbin.

3. The apparatus according to claim 1, wherein said bobbin facilitates said superconducting coils to achieve higher performance that said superconducting coils need to produce a plurality of higher magnetic fields.

4. The apparatus according to claim 1, wherein said each coil head of said apparatus to confine a plurality of charged particles includes one or more structural supports.

5. The apparatus according to claim 4, wherein said one or more structural supports are provided around said winding pack due to an increase in higher magnetic fields from said winding pack.

6. The apparatus according to claim 1, wherein said each coil head of said apparatus to confine a plurality of charged particles includes a plurality of solid strips of high strength material within said winding pack.

7. The apparatus according to claim 1, wherein said superconducting coils are reinforced superconducting coils that provide a plurality of higher magnetic fields from said winding pack.

8. The apparatus according to claim 1, wherein said 2 support legs that are in conductive contact with said each coil head are in conductive contact with said superconducting coils, said 2 support legs that are in conductive contact with said each coil head house a plurality of insulation material and a conductive rod.

9. The apparatus according to claim 1, wherein said vacuum flange is at least one port needed to utilize electrical instrumentation and one or more current leads.

10. The apparatus according to claim 1, wherein said vacuum flange is used to transition one or more instrumentation wires and said one or more leads to one or more temperature sensors and current leads to said superconducting coils from ambient condition to inside said apparatus to confine a plurality of charged particles.

11. An apparatus to confine a plurality of charged particles, comprising:
a plurality of coil heads, each said coil head includes a plurality of superconducting coils, a bobbin and a plurality of insulation material, said superconducting coils form a winding pack that is secured by said bobbin;
a plurality of support legs that include 2 support legs that are in conductive contact with said each coil head and 2 support legs that are in physical contact with said each coil heads;
a base that includes an exterior and an interior, said base has a cryocooler inlet disposed on said exterior of said base and a vacuum flange disposed on said exterior of said base, said vacuum flange is at least one port needed to utilize electrical instrumentation and one or more current leads; and
a conductive cold element that is in said interior of said base, said conductive cold element is attached to said conductive rods of said 2 support legs that are in conductive contact with said each coil head and said superconducting coils, said conductive cold element is in communication with said cryocooler inlet to receive a cryocooler device that provides cooling to said apparatus to confine a plurality of charged particles.

12. The apparatus according to claim 11, wherein said bobbin facilitates said superconducting coils to achieve higher performance that said superconducting coils need to produce a plurality of higher magnetic fields.

13. The apparatus according to claim 11, wherein said each coil head of said apparatus to confine a plurality of charged particles includes one or more structural supports.

14. The apparatus according to claim 13, wherein said one or more structural supports are provided around said winding pack due to an increase in higher magnetic fields from said winding pack.

15. The apparatus according to claim 11, wherein said each coil head of said apparatus to confine a plurality of charged particles includes a plurality of solid strips of high strength material within said winding pack.

16. The apparatus according to claim 15, wherein said high strength material is a selected one of stainless steel, nickel alloy and super alloy.

17. The apparatus according to claim 11, wherein said superconducting coils are reinforced superconducting coils that provide a plurality of higher magnetic fields from said winding pack.

18. The apparatus according to claim 11, wherein said 2 support legs that are in conductive contact with said each coil head are in conductive contact with said superconducting coils, said 2 support legs that are in conductive contact with said each coil head house a plurality of insulation material and a conductive rod.

19. The apparatus according to claim 11, wherein said vacuum flange is used to transition one or more instrumentation wires and said one or more leads to one or more temperature sensors and current leads to said superconducting coils from ambient condition to inside said apparatus to confine a plurality of charged particles.

20. The apparatus according to claim 11, wherein said conductive cold element and said conductive rods are made of copper.
